(19) United States
(12) Patent Application Publication
(10) Pub. No.: US 2015/0095303 A1
(43) Pub. Date: Apr. 2, 2015

(54) Knowledge Graph Generator Enabled by Diagonal Search

(71) Applicant: Futurewei Technologies, Inc., Plano, TX (US)

(72) Inventors: Omer Sonmez, Instanbul (TR); Zonghuan Wu, Cupertino, CA (US); Serif Adali, Istanbul (TR); Murat Kalender, Istanbul (TR); Alper Kose, Istanbul (TR)

(21) Appl. No.: 14/498,696

(22) Filed: Sep. 26, 2014

Related U.S. Application Data
(60) Provisional application No. 61/883,825, filed on Sep. 27, 2013.

(51) Int. Cl. G06F 17/30

(52) U.S. Cl. CPC G06F 17/30864; G06F 17/30734; G06F 17/30958
USPC 707/707; 707/798

(57) ABSTRACT

A method for building and managing a user-customizable knowledge base, the method comprising acquiring data related to a plurality of entities from a plurality of heterogeneous data sources based on a customized acquisition configuration, wherein the customized acquisition configuration specifies a distinct data wrapper for each of the data sources, extracting entity-related information from the data to form a number of graph databases, and integrating the graph databases by mapping relationships between the entities to create an entity-centric knowledge base.

### CROSS-REFERENCE TO RELATED APPLICATIONS

The present application claims benefit of U.S. Provisional Patent Application No. 61/883,825 filed Sep. 27, 2013 by Omer Sonmez et al. and entitled “Knowledge Graph Generator Enabled By Diagonal Search,” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

The amount of data available is ever-increasing. There were about 1.8 zettabytes of electronic data in the world in 2011, and the number is expected to reach 8 zettabytes by 2015, more than quadrupling in four years. While individuals create the majority of the data, more than eighty percent of data may be controlled by enterprises, which may store, protect, and analyze such data. In the information technology (IT) world alone, there was some 295 exabytes of stored data in 2011, and that number is now estimated to double every 2-4 years. Unstructured data may make up the bulk of the data, such as Portable Document Formats (PDFs), spreadsheets, emails, other document files, social contents, multimedia, webpages, audit and configuration data, Global Positioning System (GPS), and other document types or sensory data. Knowledge bases are information repositories that may allow information to be collected, organized, shared, searched and utilized. A knowledge base may be a central piece of a knowledge management infrastructure for an organization such as a university or an enterprise.

### SUMMARY

In one embodiment, the disclosure includes a method for building a user-customizable knowledge base, the method comprising acquiring data related to a plurality of entities from a plurality of heterogeneous data sources based on a customized acquisition configuration, wherein the customized acquisition configuration specifies a distinct data wrapper for each of the data sources, extracting entity-related information from the data to form a number of graph databases, and integrating the graph databases by mapping relationships between the entities to create an entity-centric knowledge base.

In another embodiment, the disclosure includes a data system comprising one or more processors configured to acquire data related to a plurality of entities from a plurality of heterogeneous data sources based on a customized acquisition configuration, extract entity-related information from the acquired data to form a number of graph databases, and integrate the graph databases by mapping relationships between the entities to create an entity-centric knowledge base.

In yet another embodiment, the disclosure includes a computer program product comprising computer executable instructions stored on a non-transitory computer readable medium such that when executed by a processor cause a network system to acquire data related to a plurality of entities from a plurality of search engines based on a metasearch engine configuration, generate an entity-centric knowledge base by establishing a mapping between the data related to the entities and an upper ontology that encompasses at least the search engines, and analyze contents contained in the entity-centric knowledge base to discover information associated with each entity and relationships between the entities.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is an examplary Venn diagram depicting a nexus for a Real Internet Content Enrichment (RICE) system.

FIG. 2 is a schematic diagram showing an embodiment of a RICE platform or architecture.

FIG. 3 is a schematic diagram showing examplary data extraction domains for data acquisition via data wrappers.

FIG. 4 is a schematic diagram showing an embodiment of a Prompt Internet Information Integrator (PI3) platform.

FIG. 5 is a schematic diagram showing an examplary data mapping scheme.

FIG. 6 is a schematic diagram showing an examplary entity-centric knowledge base.

FIG. 7 is a flowchart of an embodiment of a method for knowledge transformation.

FIG. 8 is a flowchart of an embodiment of a method for building a user-customizable knowledge base.

FIG. 9 is a flowchart of an embodiment of a method for operating a PI3 platform.

FIG. 10 is a schematic diagram showing an embodiment of a computer system.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Big Data may refer to data sets with huge sizes (e.g., on order of terabytes to petabytes) that may be beyond the ability of commonly used software tools to capture, curate, manage, and process within a tolerable period of time. The understanding of data may become a core competency of a business, impacting sales, marketing, production, user experience, and other aspects. In the era of Big Data, traditional technologies and systems such as data warehouse, business intelligence (BI), master data management (MDM), service-oriented architecture (SoA), etc., may not meet the ever-increasing pace of data growth. Thus, enterprises or companies may need more agile data systems to effectively manage the growth, heterogeneity, and dynamicity of the data, information and knowledge in their enterprises, so that the companies may leverage the ocean of data, information, and knowledge available on the Internet. Companies may be challenged when attempting to manage and extract value from disparate, isolated, and/or unstructured data. Specifically, there remains a lack of technologies and tools that enable small- to medium-sized companies, or departments in a big company, to effectively construct and manage their specialty knowledge graphs and knowledge bases. Such management of knowledge bases may enable them to analyze knowledge, and share (with control) the knowledge with other departments, other organizations, and/or the Internet.

Disclosed herein are embodiments of a network data system, which may generate, access, and manage a unique domain-independent, mass-customizable enterprise knowledge base. The disclosed data system is referred to herein as a Real Internet Content Enrichment (RICE) system (or simply as RICE). Disclosed data system embodiments may acquire, extract, and analyze knowledge, and may further link distributed knowledge bases together by using natural language processing, semantic web, and machine learning technologies, and the support of Big Data Infrastructure. In an embodiment, the disclosed data system may employ diagonal searching that integrates various sources such as Web 1.0 (search engines, websites), Web 2.0 (Web application programming interfaces (APIs)), and Web 3.0 (Semantic Web). The data system may integrate both structured and unstructured data sources, and convert the integrated data to semantic knowledge by connecting small graph databases or knowledge graphs together.

On the Internet, information may be presented and shared through webpages, websites, APIs, and other forms. Search engines may collect information available on the Internet to data centers and allow people to search for information stored at the data centers. However, for future web generations, it is desirable to provide web users with enabling technology and tools (such as RICE disclosed herein), so that they may express their knowledge, connect to the knowledge of others in the semantic web, and make the knowledge globally searchable without going through a central gateway. Existing knowledge management systems may be categorized into general purpose knowledge base systems and domain-specific knowledge base systems. A general purpose knowledge base may extract data from unstructured information available on web pages to create structured graph databases of the entities of the Internet such as people, places, things, and relationships among them. A domain-specific knowledge base (e.g., for news, media, or academic research) may also be organized as a graph, and may be enabled by semantic technologies.

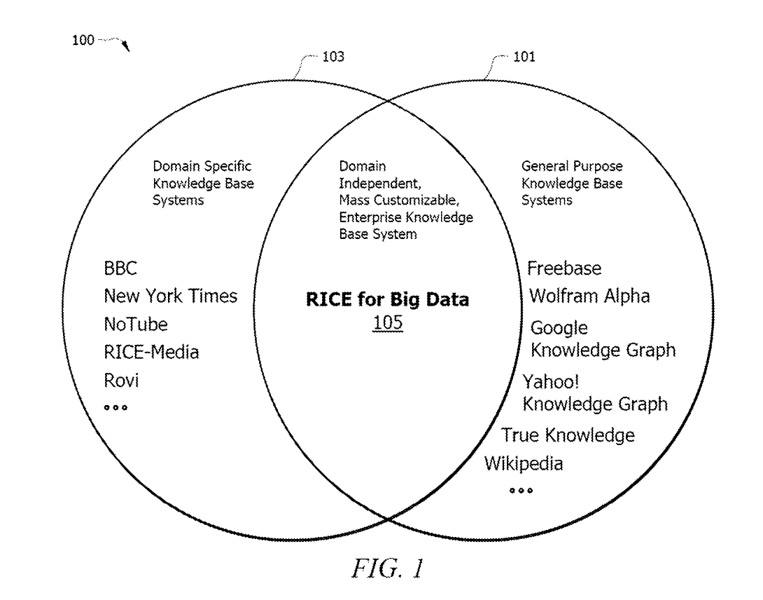

FIG. 1 is an examplary Venn diagram 100 depicting a nexus for a RICE system for Big Data and its unique position. General purpose knowledge base systems 101 may be managed by big corporations, so individual users or small enterprise may not be able to manage or customize these knowledge base systems. Domain-specific knowledge base systems 103 may be tailored to a specific industry or application, so users in other industries or applications cannot effectively use them. As shown in FIG. 1, such knowledge base systems may not focus on the space of domain-independent, mass-customizable enterprise knowledge bases. A RICE data system 105 may be employed to exploit a blue ocean business opportunity existing in small and medium enterprises (SMEs) and departments in large enterprises, e.g., from Big Data entities to small, domain-specific knowledge management systems. For instance, RICE may support SMEs that may constitute the vast majority (e.g., 95%-99%) of all businesses according to the World Bank. Similar opportunities exist on the departmental level in large enterprises. The present disclosure introduces an entity-centric knowledge base, which may have a significant impact on important product lines. Moreover, the present disclosure may enable the creation of a departmental knowledge graphs, and thereafter the linking of departmental knowledge graphs together using RICE to build the organizational entity-centric knowledge base.

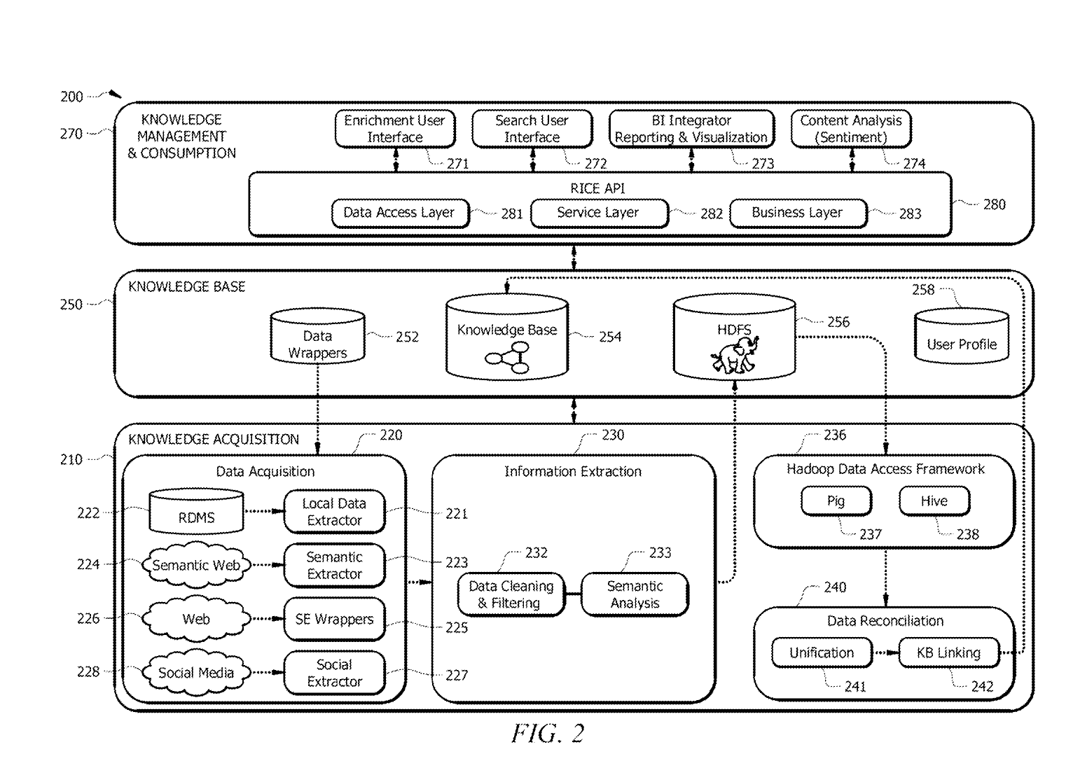

FIG. 2 is a schematic diagram showing an embodiment of a RICE platform or architecture 200, which may be an implementation of the RICE system 105 in FIG. 1. The RICE architecture 200 may be designed considering flexibility of data models and scalability of big data processing to allow user-customization. The RICE architecture 200 may be used for Big Data and may comprise three layers: a knowledge acquisition layer 210, a knowledge base layer 250, and a knowledge management and consumption layer 270, which may acquire, store, and manage data, respectively. These layers may be designed in an object-oriented fashion, considering software design principles. Integration between these layers may be realized through APIs. Such APIs may be implemented as web services such as Simple Object Access Protocol (SOAP) or Representational State Transfer (REST), but any other protocols can be employed as well. The knowledge acquisition layer 210 may extract information from internal sources (e.g., customer relationship management (CRM), billing, and contact center databases) and external sources (e.g., web pages, APIs, and social media feeds) with respect to an enterprise to create a knowledge-driven approach for information retrieval. Main modules of the knowledge acquisition layer 210 may include a data acquisition module 220, an information extraction module 230, a Hadoop data access framework 236, and a data reconciliation module 240. Specifically, the data acquisition module 220 may allow users to define data extraction procedures from internal sources and external sources. In an embodiment, the data acquisition module 220 may comprise a local data extractor 221 for acquiring data from a remote data management system (RDMS) 222, a semantic extractor 223 for acquiring data from a semantic web source 224, search engine (SE) wrappers 225 for acquiring data from another web source 226, and a social extractor 227 for acquiring data from a social media source 228.

The information extraction module 230 may extract entity-related data, map the data to a corresponding domain ontology, and store the data in a Hadoop Distributed File System (HDFS) 256 for post processing. Information extraction may refer to the task of automatically extracting structured information from unstructured and/or semi-structured machine-readable documents. Various methods may be used herein to extract entities with their field values. The information extraction module 230 may clean the acquired data before the integration process using a data cleaning and filtering unit 232. In an embodiment, data from multiple sources may be cleaned or normalized to have the same format. For example, an extracted address “37 MAIN STREET” may need to be transformed into “37 Main St.” to fit into a naming convention of existing data sources. Further, the data cleaning and filtering unit 232 may filter duplicative or incomplete entities. For example, if two data sources return an identical address “37 Main St,” one is a duplicate and may be filtered out. For another example, if a third data source returns an incomplete address “37 Main,” the third address may be removed as well.

The information extraction module 230 further comprises a semantic analysis unit 233 for extracting metadata from the acquired data to enrich data. For example, The semantic analysis unit 233 may discover relationships between entities, and annotate the acquired data with existing entities and entity relationships defined in the knowledge base. Any relevant metadata can be extracted using semantic analysis tools. For instance, a movie description may have metadata such as the movie's director, actors, runtime, and location of where the movie has been made, which are all entities. Using semantic analysis tools, any relevant metadata about the movie (entity) may be obtained. For instance, the user will be able to search the director of the movie (entity).

For big data processing and analysis, a Hadoop distributed computing framework may be used to process large data sets across clusters of computers using simple programming models. The Hadoop data access framework 236 may provide a simplified access to the HDFS 256 with two solutions of Hadoop, known as Pig 237 and Hive 238. Pig 237 is a programming language that may simplify the common tasks of working with Hadoop. Such tasks include loading data, expressing transformations on the data, and storing the final results. Hive 238 may allow Hadoop to operate as a data warehouse. Hive 238 may superimpose structure on data in the HDFS 256, and then permit queries over the data using a familiar Structured Query Language (SQL) or SQL-like syntax. The HDFS 256 may store data in a Hadoop cluster, which may be broken down into smaller pieces (called blocks) and distributed throughout the cluster. In this way, map and reduce functions may be executed on relatively smaller subsets of larger data sets, thereby providing scalability needed in processing big data.

The data reconciliation module 240 may merge the extracted data for entities and map relationships between entities to form an entity-centric knowledge base. The data reconciliation module 240 may use a Hadoop data processing (e.g., Map-Reduce) framework to handle big data via parallel computing on server clusters. The data reconciliation module 240 may comprises a unification unit 241 and a knowledge base linking unit 242. The unification unit 241 may handle the unification of extracted data from various sources. For example, different formats of an identical field (e.g., an address or movie title) retrieved from different sources may be unified to remove duplication. In addition, the knowledge base linking unit 242 may discover relationships between existing and new entities, and may update the knowledge base accordingly. Information extraction and unification may process human language texts using Natural Language Processing (NLP), which is a group of functions related to computer science, artificial intelligence, and linguistics concerned with the interactions between computers and human (natural) languages.

The knowledge base layer 250 may contain data storages for the RICE platform 200. Specifically, one or more data wrappers 252 may be configured to store extraction procedures (e.g., web data extractors and enrichment rules) for extracting data from various sources. The knowledge base 254, as the output of the data reconciliation module 240, may store integrated and unified entity-centric knowledge base in a graph structure with a common upper ontology. An upper ontology may describe general concepts that are the same or similar across most, if not all, knowledge domains. The upper ontology may support very broad semantic interoperability between a large number of domain ontologies that are accessible under the upper ontology. One of ordinary skill in the art would recognize that various graph databases may be leveraged herein, including InfiniteGraph, Neo4j, FlockDB, GraphDB, Titan, OrientDB, and semantic stores (e.g., Virtuoso, Apache TDB, and AllegroGraph). Entity-related information may be collected from internal and/or external sources (e.g., metadata, social media feeds, etc.) with respect to an enterprise and then stored in the knowledge base 254 in a graph structure. Edges of the knowledge base 254 may refer to relations between entities. Moreover, the HDFS 256 may be a distributed file system that stores extracted information for Big Data analysis. The user profile module 258 may manage user information such as account information, authentication data, search history, and personal preferences that may be used for personalization of the search results.

The knowledge management and consumption layer 270 may provide a selection of APIs and web services for managing and accessing knowledge available in the RICE platform 200. The knowledge management and consumption layer 270 may be used both by end users to search on the knowledge base and by developers or operators to define rules/sources to create and maintain the knowledge base. As shown in FIG. 2, the knowledge management and consumption layer 270 may comprise an enrichment user interface module 271, a search user interface module 272, a BI integrator module 273, a content analysis module 274, and an API module 280. The enrichment user interface module 271 may allow users to define enrichment rules for unifying data from heterogeneous internal and external sources. The search user interface module 272 may allow end users to search an entity-centric knowledge base and present the results on an enriched user interface or experience. The BI integrator module 273 may allow integration BI tools to analyze the generated knowledge base. The BI integrator module 273 may also report and visualize its analysis.

The content analysis module 274 may allow dynamic integration of third party or custom data analysis tools, such as sentiment analysis, summarization, and recommendation tools. The content analysis module 274 may discover information about an entity from contents contained in the entity. For instance, several companies provide analysis through their customer care services tools (e.g., discussion forums), allowing a customer to directly communicate with the company, or to share opinions and comments with other customers of the company. Messages exchanged in a discussion forum may be extracted and analyzed to identify trending discussion topics, and to measure the level of satisfaction perceived by the customers. Such information may be valuable because it allows company managers to design strategies to increase the quality of services or products delivered to customers. As shown in FIG. 2, the knowledge management and consumption layer 270 may communicate with lower layers through an API module 280. The API module 280 may comprise multiple layers such as a data access layer 281, a service layer 282, and a business layer 283.

The RICE platform 200 may allow enterprises to build their tailored entity-centric, graph-modeled, scalable knowledge bases on demand to serve their customized needs. The RICE platform 200 may access, transform, integrate (e.g., by building semantic relationships), and publish large-scale data from heterogeneous (e.g., some structured and some unstructured) sources including internal sources (e.g., enterprise intranet) and external sources (e.g., the Internet). The RICE platform 200 may create real-time or near real-time complex knowledge services that can be leveraged by both applications and humans. RICE's flexible data format may allow enterprises to harvest a wide variety of disparate data sources and seamlessly merge the data sources into a homogenous format, which may connect or link entities regardless of where the entities are extracted from. In summary, the disclosed RICE platform 200 may facilitate enterprises to leverage data by (1) increasing the discoverability of enterprise data, (2) enabling interoperability between entities, (3) enabling interoperability with external data sources, (4) increasing the internal reuse of knowledge across products, and (5) increasing the efficiency of knowledge management.

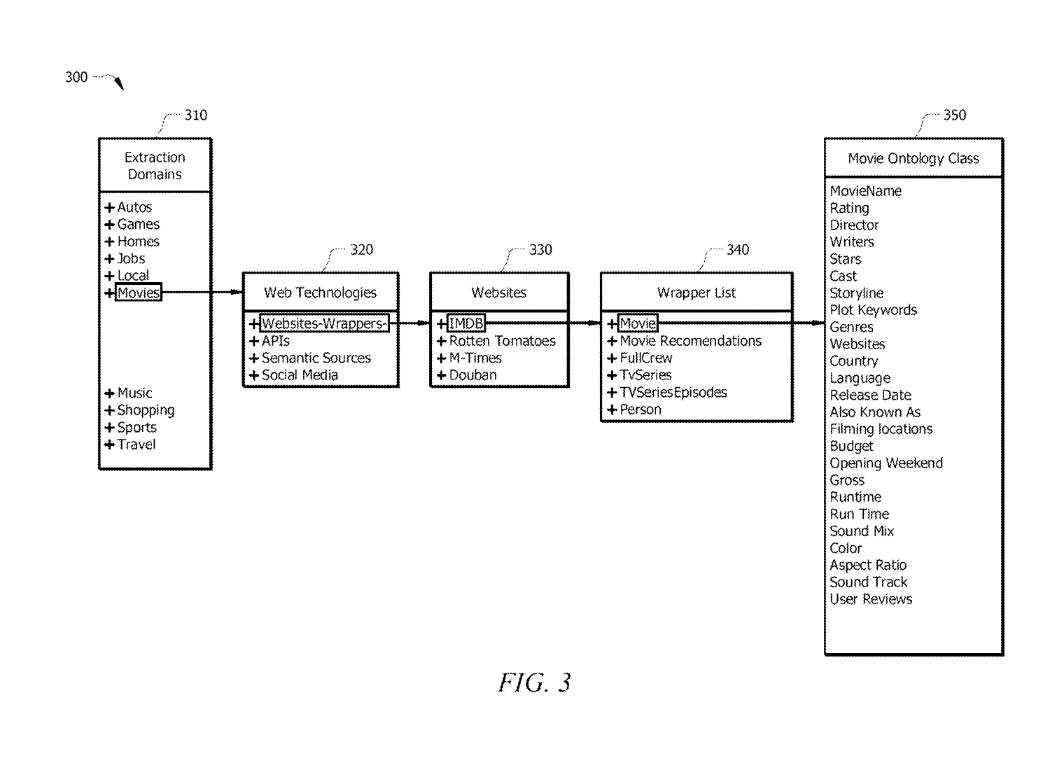

FIG. 3 illustrates examplary data extraction domains 300 for data acquisition via data wrappers, which may be implemented in a data system such as the RICE platform 200 in FIG. 2. The extraction domains may be designed for various applications 310 such as automobiles (autos), games, homes, jobs, local, movies, music, shopping, sports, travel, etc. Each piece of domain-specific information may be extracted through web technologies 320 such as website wrappers, APIs, semantic sources, and/or social media. The website wrappers, for instance, may be used on various websites 330 such as Internet Movie Database (IMDB). In the example shown in FIG. 3, a movie wrapper may extract information from the IMDB website. A wrapper list 340 may extract various data from the IMDB website, such as movie, movie recommendations, full crew, television (TV) series, person, etc. The Movie ontology class 350 may further include more detailed information such as movie name, rating, director, writers, genres, etc. In an embodiment, distinct wrappers may be designed for extracting information from different web pages. Wrapper design may be simple as not to require any knowledge of programming languages from the designer. When using a data wrapper to extract information from a website, initially a user may search for and access web pages that he/she would like to extract contents from. Then, the user may highlight the area to be extracted. Finally, a wrapper designer may compose the extracted contents to one representation.

In an embodiment, a Prompt Internet Information Integrator (PI3), developed by HUAWEI® and sometimes simply referred to as PI3, may be taken as a platform or tool for wrapper design. Through an API of the PI3 platform, a web developer may be connected to many (e.g., hundreds of thousands of) search engines. In addition, through a PI3 portal, a web developer may create a customized metasearch engine instantly on many search engines. For example, a diagonal search may combine horizontal search engines and vertical search engines to realize metasearch engines. A horizontal search engine may refer to a general purpose search engine, and a vertical search engine may refer to a specialized search engine. A vertical search engine may index contents specialized by location, by topic, or by industry, and may be geared to businesses or enterprises. Instead of returning thousands of links from a query, which may be common on a general purpose search engine, a vertical search engine query may deliver more relevant results to the user. The scope of the PI3 platform may include wrapper generation, web data extraction, and search engine recommendation. Its functionality may include (1) search engine incorporation, where a wrapper may be generated for a search engine through an interactive configuration process at the PI3 interface; (2) the assembly of a metasearch engine on incorporated search engines, where a subset of incorporated search engines may be grouped to create a customized metasearch engine through an interactive configuration process at the PI3 interface; and (3) metasearch through PI3, where a metasearch engine created in part component (2) can be searched.

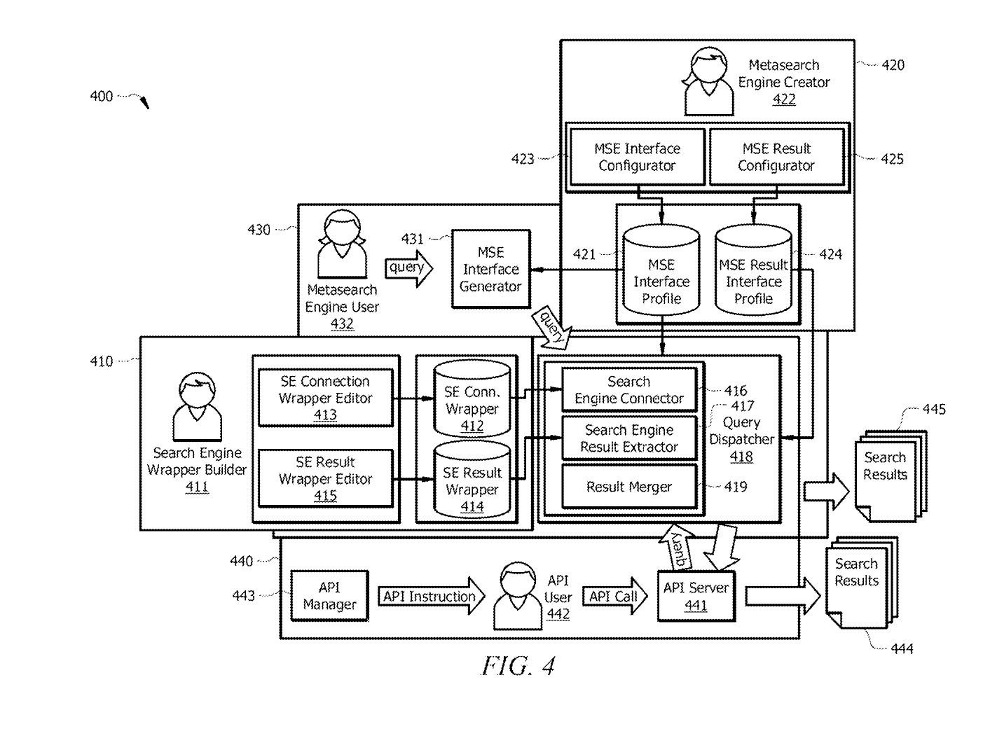

FIG. 4 illustrates an embodiment of a PI3 platform or architecture 400, which may be implemented as part of the RICE platform 200 in FIG. 2. The PI3 platform may comprise a search engine wrapper building component 410, a metasearch engine (MSE) configuration component 420, a metasearching component 430, and an API service component 440. In the search engine wrapper building component 410, configuration information describing a search engine may be collected into a wrapper. Wrapper information may be divided as a search engine connection wrapper 412 and a search engine result extraction wrapper 414. A search engine wrapper builder 411 may design or edit the search engine connection wrapper 412 using a search engine connection wrapper editor 413, and may design or edit the search engine result wrapper 414 using a search engine result wrapper editor 415. A search engine's interface, e.g., its HyperText Markup Language (HTML) form, may be profiled into the search engine connection wrapper 411. A search engine connector 416 may read wrappers of different search engines and text queries to get a result page back from search engines. Thus, universal search engine connection capability may be provided. In the search engine result extraction wrapper 414, the features of a search engine's result returned from querying may be described and saved in the search engine's result wrapper. A search engine result extractor 417 may read the wrappers of different search engines to extract each result from the search engine's result page. Thus, universal search engine result extraction capability may be provided. A query dispatcher 418 may further comprise a result merger 419 for merging search results 445 from multiple search engines.

In the metasearch engine configuration component 420, a metasearch engine that searches multiple search engines may be constructed, configured, and saved into a metasearch engine profile. The metasearch engine configuration component 420 may further comprise two parts: a SE-MSE interface matching and mapping part and a SE-MSE result schema matching and mapping part. In the SE-MSE interface matching and mapping part, a metasearch engine interface profile 421 may be configured by a metasearch engine creator 422 using a metasearch engine interface configurator 423. Each search engine's interface may have a form that may have multiple parameters, so the parameters may be mapped to corresponding parameters of a metasearch engine's form. By mapping parameters of the metasearch engine form to corresponding parameters of each search engine, the PI3 platform 400 may properly convert a metasearch engine query into a query that is recognized by an underlying search engine. Further, in the SE-MSE result schema matching and mapping part, a metasearch engine result interface profile 424 may be configured by the metasearch engine creator 422 using a metasearch engine result configurator 425. A metasearch engine may use a mapping between each field of a result record of a search engine and a field of a record of a metasearch engine in order to display results returned from multiple underlying search engines in an integrated manner. With such mapping, the PI3 platform 400 may properly display data results within the integrated result interface of the metasearch engine.

In the metasearching component 430, a metasearch engine that searches multiple search engines may be constructed, configured, and saved into a metasearch engine profile. The PI3 platform 400 may understand the metasearch engine wrapper, and may use a metasearch engine interface generator 431 in the metasearching component 430 to generate a metasearch engine interface. A metasearch engine user 432 may use the PI3 platform 400 to search multiple search engines, extract results, and compose or forward the results to a unified metasearch engine result interface. Further, REST API calls can be served in the API service component 440. REST is an architectural style comprising a coordinated set of architectural constraints applied to components, connectors, and data elements, within a distributed hypermedia system. For example, using a search engine query API Call, an API server 441 may properly connect to a search engine, send a query, and return structured results back to an API requester. The API requester may be an API user 442 who received an API instruction from an API manager 443. For another example, in a metasearch engine query API Call, PI3 the PI3 platform 400 may conduct the metasearch, and then return structured and integrated search results 444 back to the API requester. The search results 444 may be forwarded to a unified metasearch engine result interface for display.

FIG. 5 illustrates an examplary data mapping scheme 500, which may be implemented in the RICE platform 200 in FIG. 2. When performing a metasearch, fields or parameters, including the uniform resource locator (URL) and movie title fields, of a metasearch engine 510 may be mapped to corresponding fields or parameters of different search engines 520, 530, and 540. With such mapping, a RICE platform may properly convert a metasearch engine query into a query that is recognized by the underlying search engines 520, 530, and 540. The mapping may also allow the metasearch engine 510 to display results returned from the search engines 520, 530, and 540 in an integrated manner. Further, duplicative copies of the URL and the title of a movie from different search engines may be filtered from the search results. In other words, multiple data fields for the same entity-related information may be combined or consolidated to fit a uniform data format.

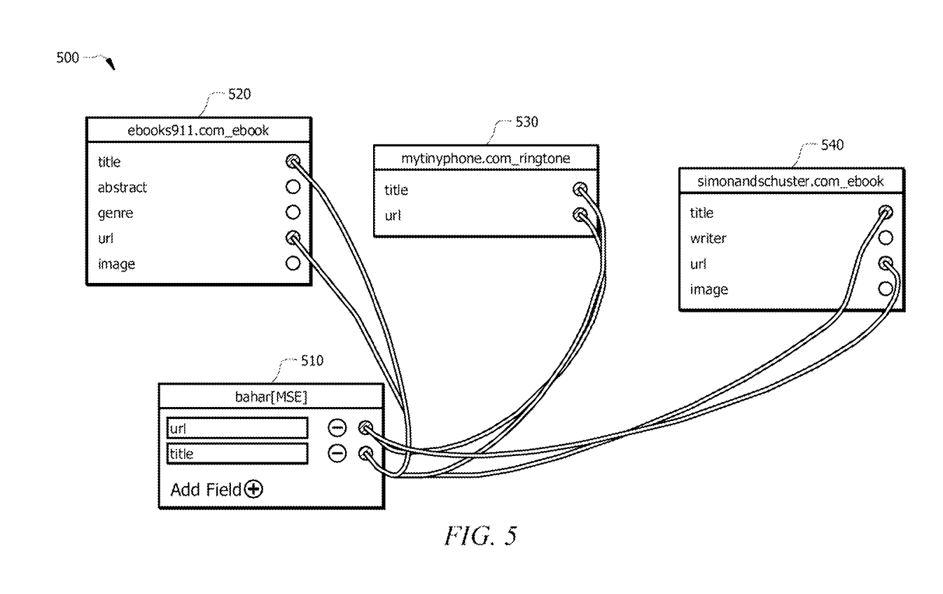

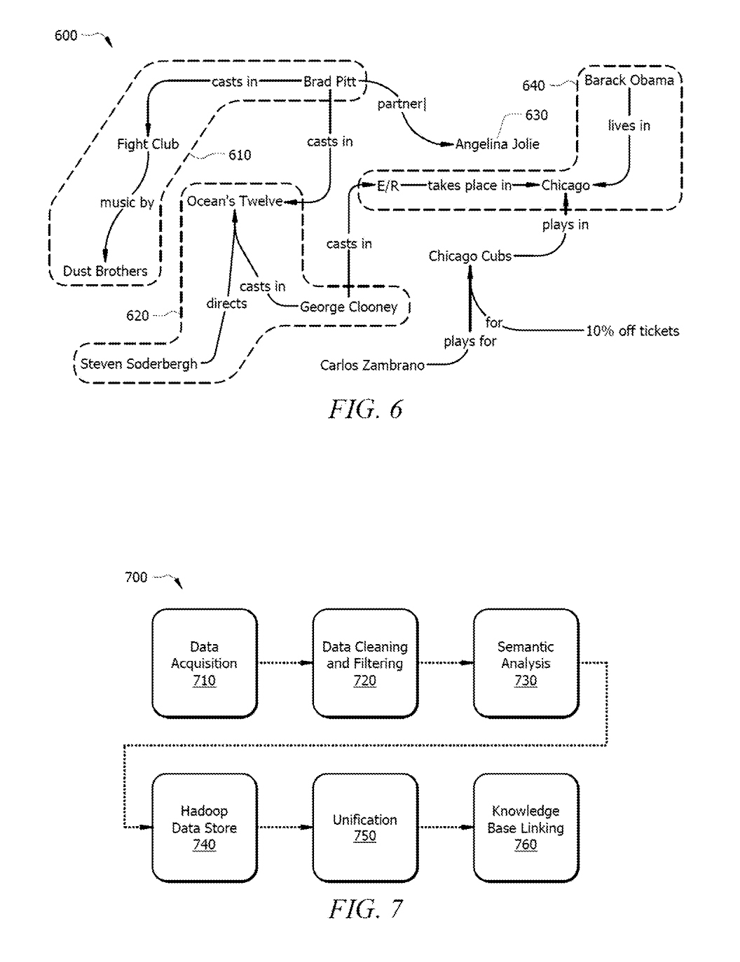

To construct a knowledge base, graph databases may be used so that the schema-free nature of the graph databases may realize easy customization of the knowledge graph for different enterprises and allow fast access to knowledge (e.g., short query response time). A graph database (or knowledge graph) may have any size or contain any information in one or more graph structures where nodes represent entities and edges define the relation across entities. FIG. 6 illustrates an embodiment of an entity-centric knowledge base 600, in which domain entities, such as actors, movies, cities, and other information, are linked to each other to provide enriched information. The knowledge base 600 may be implemented as the knowledge base 254 in FIG. 2. An entity may refer to any piece of information, such as a person, an event, a location, etc. The entity-centric knowledge base 600 comprises information about the entities and relationships between the entities. In an embodiment, the knowledge base 600 may be generated by integrating a number of graph databases including graph databases 610, 620, 630, and 640. The graph database 610 contains information or contents centered around the entity of movie Fight Club, describing its music producer and lead actor Brad Pitt. The graph database 620 contains information centered around the entity of another movie Ocean's Twelve, describing its director and lead actor George Clooney. The graph database 630 describes a single entity Angelina Jolie, who was a partner (now wife) of Brad Pitt. The graph database 640 describes a show Emergency Room (E/R) that takes place in Chicago, where Barack Obama lives. Thus, the graph databases 610 and 620 may be integrated by specifying relationships linking the graph databases, e.g., the fact that Brad Pitt has also casted in Ocean's Twelve. The relationships may be discovered by performing analysis on collected text data using a semantic analysis unit (e.g., the unit 233 in FIG. 2). Thus, mapping relationships between the entities of different graph databases may lead to the entity-centric knowledge base 600 with enriched information related to its entities.

FIG. 7 is a flowchart of an embodiment of a method 700 for knowledge transformation, which illustrates how to collect and transform data to knowledge using a RICE platform such as the RICE platform 200 in FIG. 2. In step 710, internal enterprise data or external web data may be collected based on a pre-defined data acquisition configuration. The data acquisition configuration may include data wrappers for extracting information from entity-related data sources in target domains. In step 720, the collected data may be cleaned and filtered to enhance its quality. For example, step 720 may normalize data and filter duplicate and/or incomplete entities. In step 730, semantic data analysis may be performed in which the filtered data may be mapped to a corresponding domain ontology (e.g., a semantic data model). In step 740, the mapped data may be stored in a distributed and scalable data store, such as a Hadoop Data Store or a HDFS. The HDFS may be able to process (in data reconciliation) and analyze a large volume of data, thus HDFS is suitable for Big Data. In step 750, data from various sources for each entity may be unified to yield a single result. In step 760, based on the extracted entities, discovered entities and/or relations may be added into a knowledge base. The added entities/relations may be linked to the existing entity relations/properties.

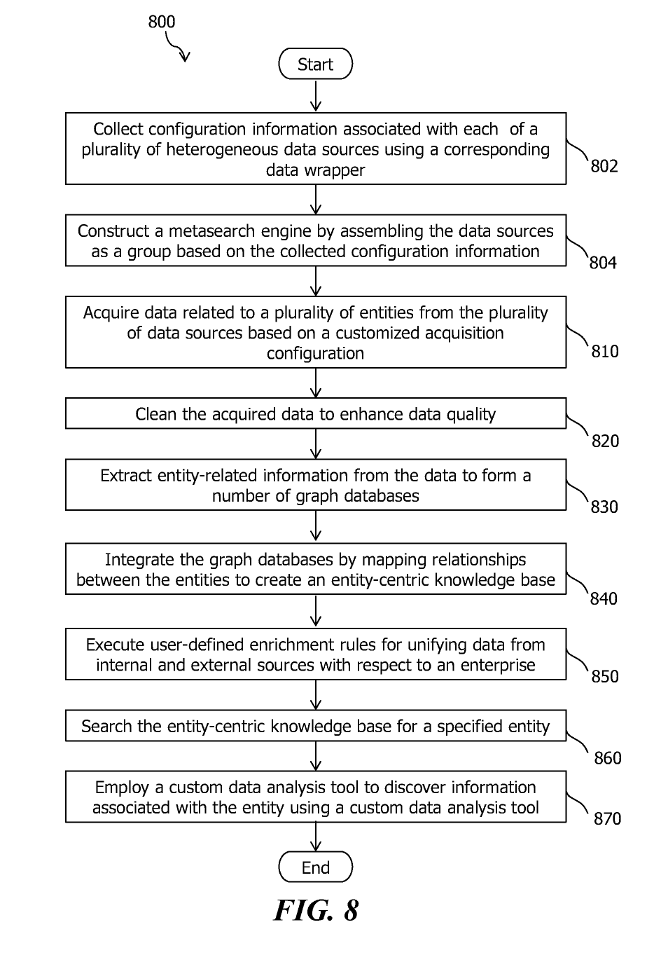

FIG. 8 is a flowchart of an embodiment of a method 800 for building, using, and managing a user-customizable knowledge base such as the knowledge base 254 in FIG. 2. The method 800 may be implemented by a data system or a network system (e.g., the RICE platform 200 in FIG. 2), which may be centralized or distributed. The method 800 may start in step 802, where configuration information associated with each of a plurality of heterogeneous data sources may be collected or incorporated using a corresponding data wrapper. The data sources may be any source, such as a search engine or a discussion forum, accessible to the data system. The configuration information may include any relevant information (e.g., forms, parameters, fields, etc.). In step 804, a metasearch engine may be constructed by assembling the data sources as a group based on the collected configuration information. The metasearch engine may implement a piped execution.

In step 810, data related to a plurality of entities may be acquired from a plurality of heterogeneous data sources based on a customized configuration. As discussed above, the entity-centric knowledge base may be used by an enterprise or company that accesses both internal data sources and external data sources. Thus, at least part of the relationships may be mapped between entities of the internal data sources and entities of the external data sources. In an embodiment, the customized configuration may specify a distinct data wrapper for each of the data sources. For example, the customized acquisition configuration may be configured using a PI3 platform. In this case, the step 810 may comprise sub-steps of querying the data sources using the metasearch engine, and forwarding the acquired data as search results to a unified metasearch engine result interface for display. In another embodiment, the customized configuration may be defined by (a) configuring a customizable data model (e.g., specifying model/data structure/data organization/ontology) for the entity-centric knowledge base; (b) configuring the data wrapper for each data source by defining rules for acquiring the data from the data sources and rules for extracting the entity-related information; and (c) configuring data integration (metasearch/pipe) and semantification rules. Semantification rules control the flow of information between extracted information and a knowledge graph.

In an embodiment, each of the data sources may comprise an interface form with parameters, and the metasearch engine may comprise another interface form with parameters. In this case, searching the data sources may further comprise: (a) mapping parameters of the metasearch engine to corresponding parameters of the data sources, (b) converting a metasearch engine query to a query that is recognized by all of the data sources based on the mapping of the parameters, (c) sending the search engine query to the data sources, and (d) mapping each field of a result record of the data source to a corresponding field of a result record of the metasearch engine.

In step 820, the method 800 may clean the acquired data to enhance data quality. Cleaning the data may comprise normalizing the acquired data such that corresponding fields of the acquired data from the data sources have a common data format, and filtering the acquired data to remove duplicative or incomplete entities. In step 830, the method 800 may extract entity-related information from the cleaned data to form a number of graph databases. In step 840, the method 800 may integrate the graph databases by mapping relationships between the entities to create an entity-centric knowledge base. Mapping the relationships between the entities may link the graph databases together as integral parts of the entity-centric knowledge base. Moreover, integrating the graph databases may further comprise: (1) unifying formats of the graph databases according to one common data format before mapping the relationships (e.g., although cleaning module 232 may clean data from one data/content source, data for an entity may come from multiple data sources and thus should be unified in format), and (2) storing the entities and the mapped relationships in an HDFS that is designed to process big data.

In step 850, the method 800 may execute user-defined enrichment rules for unifying data from heterogeneous internal and external sources with respect to an enterprise. In step 860, the method 800 may search the entity-centric knowledge base for a specified entity. In step 870, the method 800 may employ a custom data analysis tool to discover information associated with the entity using a custom data analysis tool. Note that the access and management of the knowledge base may not require special programming knowledge in order to achieve user friendliness and flexibility. For instance, data wrapper for each of the data sources may be designed without a need for programming, and wherein the enrichment rules are defined without a need for programming.

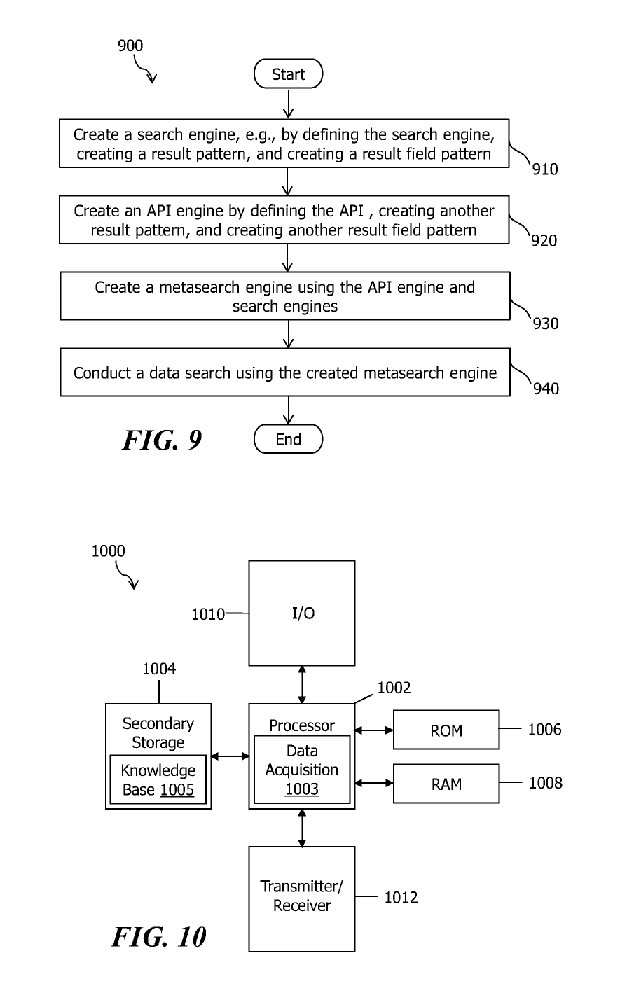

FIG. 9 is a flowchart of an embodiment of a method 900 for operating a PI3 platform such as the PI3 platform 400 in FIG. 4. In step 910, a search engine may be created, e.g., by defining the search engine, creating a result pattern, and creating a result field pattern. When defining the search engine, parameters such as activity keywords, class keywords, clause keywords, a JavaScript enabling flag, a logo URL, and an engine type, etc., may be specified. When creating the result pattern, tag types (e.g., local tag, parent tag, or child tag) may be determined for the search engine. When creating the result field pattern, a field name and a tag attribute may be specified. In step 920, an API engine may be created, e.g., by defining the API engine, creating another result pattern, and creating another result field pattern. In step 930, a metasearch engine may be created using the API engine and search engines. Any number of search engines that have been created may be added or incorporated into the metasearch engine, and parameters of each engine may be mapped to corresponding parameters of the metasearch engine. In step 940, a data search may be conducted using the created metasearch engine. For instance, a text keyword may be entered to allow the metasearch engine to search for specified information on multiple selected search engines.

The schemes described herein may be implemented on one or more network components, such as a computer or network component with sufficient processing power, memory resources, and network throughput capability to handle the necessary workload placed upon it. FIG. 10 illustrates an embodiment of a system 1000, which may be a computer system, data system, network system, or network node suitable for implementing any and/or every component in the systems disclosed herein (e.g., the RICE platform 200 and/or the PI3 platform 400). The system 1000 includes a processor 1002 that is in communication with memory devices including a secondary storage 1004, a read only memory (ROM) 1006, a random access memory (RAM) 1008, input/output (I/O) devices 1010, and transmitter/receiver (transceiver) 1012. Although illustrated as a single processor, the processor 1002 is not so limited and may comprise multiple processors. The processor 1002 may be implemented as one or more central processing unit (CPU) chips, cores (e.g., a multi-core processor), field-programmable gate arrays (FPGAs), application specific integrated circuits (ASICs), and/or digital signal processors (DSPs). The processor 1002 may be implemented using hardware or a combination of hardware and software. In an embodiment, the processor 1002 may comprise a data acquisition module 1003, which may be similar to the data acquisition module 220 in FIG. 2, and any other suitable components of the disclosed data system. For example, data acquisition module 1003 may be configured to implement at least part of any of the schemes or methods described herein, including the data mapping scheme 500, the method 700 for knowledge transformation, the method 800 for building a user-customizable knowledge base, and the method 900 for operating a PI3 platform.

The secondary storage 1004 is typically comprised of one or more disk drives, solid state drives, or tape drives and is used for non-volatile storage of data and as an over-flow data storage device if the RAM 1008 is not large enough to hold all working data. The secondary storage 1004 may be used to store programs that are loaded into the RAM 1008 when such programs are selected for execution. In an embodiment, the secondary storage 1004 may store a knowledge base 1005, which may be similar to the knowledge base 254 in FIG. 2, and any other suitable data or information. The ROM 1006 is used to store instructions and perhaps data that are read during program execution. The ROM 1006 is a non-volatile memory device that typically has a small memory capacity relative to the larger memory capacity of the secondary storage 1004. The RAM 1008 is used to store volatile data and perhaps to store instructions. Access to both the ROM 1006 and the RAM 1008 is typically faster than to the secondary storage 1004.

The transmitter/receiver 1012 (sometimes referred to as a transceiver) may serve as an output and/or input (I/O) device of the system 1000. For example, if the transmitter/receiver 1012 is acting as a transmitter, it may transmit data out of the system 1000. If the transmitter/receiver 1012 is acting as a receiver, it may receive data into the system 1000. Further, the transmitter/receiver 1012 may include one or more optical transmitters, one or more optical receivers, one or more electrical transmitters, and/or one or more electrical receivers. The transmitter/receiver 1012 may take the form of modems, modem banks, Ethernet cards, universal serial bus (USB) interface cards, serial interfaces, token ring cards, fiber distributed data interface (FDDI) cards, and/or other well-known network devices. The transmitter/receiver 1012 may allow the processor 1002 to communicate with an Internet or one or more intranets. The I/O devices 1010 may be optional or may be detachable from the rest of the system 1000. The I/O devices 1010 may include a display such as a touch screen or a touch sensitive display. The I/O devices 1010 may also include one or more keyboards, mice, or track balls, or other well-known input devices. Further, the system 1000 may be implemented over a plurality of devices, e.g., as a cloud computing system.

It is understood that by programming and/or loading executable instructions onto the system 1000, at least one of the processor 1002, the secondary storage 1004, the RAM 1008, and the ROM 1006 are changed, transforming the system 1000 in part into a particular machine or apparatus (e.g. part of the RICE architecture 200 having the functionality taught by the present disclosure). The executable instructions may be stored on the secondary storage 1004, the ROM 1006, and/or the RAM 1008 and loaded into the processor 1002 for execution. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an ASIC, because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner, as a machine controlled by a new ASIC is a particular machine or apparatus, likewise a computer that has been programmed and/or loaded with executable instructions may be viewed as a particular machine or apparatus.

It should be understood that any processing of the present disclosure may be implemented by causing a processor (e.g., a general purpose CPU inside a computer system) in a computer system (e.g., the RICE platform 200 or the PI3 platform 400) to execute a computer program. In this case, a computer program product can be provided to a computer or a network device using any type of non-transitory computer readable media. The computer program product may be stored in a non-transitory computer readable medium in the computer or the network device. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), compact disc ROM (CD-ROM), compact disc recordable (CD-R), compact disc rewritable (CD-R/W), digital versatile disc (DVD), Blu-ray (registered trademark) disc (BD), and semiconductor memories (such as mask ROM, programmable ROM (PROM), erasable PROM), flash ROM, and RAM). The computer program product may also be provided to a computer or a network device using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

For enterprises, embodiments of the disclosed RICE platform may be used for various applications, ranging from content enrichment to enterprise linked data services. Several examplary application areas are described below, including enterprise (web) mashup, single view of customers, visualization and reporting, enterprise social graph, and enterprise search.

Enterprise (web) mashup is an examplary application of RICE. The latest generation of web tools and services may allow enterprises to generate web applications that combine content (e.g., heterogeneous digital data and applications) from multiple sources, and provide the web applications as unique services to suit their situational needs. This type of web application may be referred to as a mashup. Creating a mashup application involves solving multiple problems, such as extracting data from multiple web sources, cleaning the data, and combining all data together. The RICE platform may not only tackle these issues, but also allow processing of large volumes of data in a scalable manner.

Single view of customers is another examplary application of RICE. Many companies today may still have disconnected views of their customers across products, divisions, applications and time. They may struggle to unify many fragments into a complete picture. In the business world, it may be useful to assemble a holistic view of customers including competitive choices available to each specific customer, customer feedbacks, preferences and lifestyle information that may indicate future sales opportunities or provide ideas for product improvement. The holistic view may be achieved by merging and building relevance across structured customer application data, unstructured call notes and emails, competitor and public websites, and user-generated data in blogs and reviews, etc. The RICE platform may combine detached customer information in an enterprise to assemble a holistic view for each customer.

Visualization and reporting is yet another examplary application of RICE. Businesses may have collected data, analyzed it using a variety of BI tools, and generated reports. However, Big Data brings new challenges to visualization because of the large volumes, different varieties and varying velocities that may be taken into account. For instance, with Big Data, an increasingly large percentage of the data may be unstructured, and valuable information may be hidden across different sources such as news articles, emails, blogs, review websites, rich site summary (RSS) feeds, documents, reports, and/or research papers, etc. By unifying the unstructured and unconnected data into a common format, the verticals of data may be flattened and analyzed together. The disclosed RICE platform may seamlessly merge and link data into a homogenous format, and further facilitate visualization of data using tools that can be connected through an API interface (e.g., Restful API).

Enterprise Social Graph is yet another examplary application of RICE. Good relationships may be key to a successful business. Business applications may create social graphs that map relationships between people and various types of business objects, but only within the boundaries of a single application. For instance, while CRM applications may map relationships between employees, customers, and prospects, customer support applications may map the relationship between employees and support tickets. This mapping difference may result in siloed and/or unconnected data in the enterprise (e.g., no mapping between customers and support tickets). The disclosed RICE platform may connect the data from such applications, thereby creating an enterprise social graph that comprises a holistic mapping of people and objects they encounter at work.

Enterprise Search is yet another examplary application of RICE. Integrated with enterprise search engines, RICE may improve search experience and allow new search features. A search may no longer need to be based only on keywords, but may also involve semantics, entity relationship, and other contexts. For example, an enterprise knowledge graph may help enterprise users on various aspects such as knowledge discovery, multi-facet search, the optimization of search result ranking algorithms, query extension, recommendation, and summarization.

In practice, various metrics may be employed to evaluate the performance of a knowledge base disclosed herein. For example, coverage is a metric for the quality of a knowledge base that measures a number of domains and a number of entities within domain types. Richness measures how attributes and relations populated for each entity enriches a knowledge base. With more attributes and relations, one may gather more comprehensive information about an entity. For instance, more detailed information about an actor or a retail product may be attractive to a customer. Comprehensiveness may measure a percentage of important entities/relations/facts found in the knowledge base and a percentage of entities/relations/facts mentioned in search queries and news articles. Correctness may measure accuracy of entity types and extracted fact. Besides correctness of relations and attribute, values may be useful as well. Interlinking may measure precision and recall of reconciliation. Level of interlinking across internal sources, external sources may enrich knowledge base. Freshness may measure recency of entities/relations/attributes compared to activity associated with them (popularity, trending/decay, time sensitivity, etc.). Freshness may encourage continuous acquisition of data and maintenance of the knowledge database. When determining the metrics, benchmark tests may be run over large data sets that represent both internal customer data and external web data.

In order for a RICE platform to consume data from a global data space in an integrated fashion, a number of factors may be considered. A first factor is the complexity of transforming heterogeneous cross-domain data to knowledge. In an embodiment, knowledge may be represented in an upper ontology (e.g., schema.org, Cyc, Umbel), wherein Cyc is an artificial intelligence project that attempts to assemble a comprehensive ontology and knowledge base of everyday common sense knowledge. Mapping between heterogeneous cross-domain data to upper ontology may be done by user-defined (e.g., manual) mapping rules. Mapping rules may be defined for each data source through a flexible user interface, which may not require any knowledge of programming. For an entity in the knowledge base, conflicting values may be extracted from heterogeneous data sources. Rule-based data integration techniques may be used to handle this problem.

A second factor or goal is to ensure the freshness, completeness, and correctness of the knowledge base. Freshness of knowledge may be ensured by implementation of a task scheduler, which may be responsible for running a knowledge acquisition process at scheduled times or specified time intervals to update existing knowledge. Completeness and correctness of knowledge may be ensured by extracting data from heterogeneous sources and unifying them within specific entities. A third factor is the automatic discovery of relations between entities, in other word, inter-linking entities in the knowledge base. Any suitable entity inter-linking techniques may be implemented for handling the third factor. A fourth factor is the ability to process and analyze large amounts of data, hence achieving scalability. The Apache Hadoop framework may be used to allow handling large amounts of data.

The RICE for Big Data platform disclosed herein may present a unique, scalable, highly-customizable, entity-centric, cross-domain knowledge base, e.g., to small organizations that have a lack of professional resources and/or expertise to create and manage their own knowledge graphs. This platform may address how to effectively and efficiently manage the large, heterogeneous, autonomous, and dynamic data, how to extract and analyze knowledge, how to integrate distributed knowledge bases together with semantic model and technologies, as well as the support of Big Data infrastructure. Thus, an enterprise may utilize the Big Data infrastructure to meet their business needs by leveraging large amounts of internal and/or external data. Furthermore, by using the disclosed platform, customers and/or internal product lines of an enterprise may process and analyze Big Data to create their customized knowledge bases with which they can build utility applications or services.

To provide a functional and customizable solution using RICE, the data system may enhance the process of data acquisition and unification in a highly scalable manner. The data system may contain custom ontology designs, alignment modules, wrapper-ontology mapping, and semantic data linking modules. The disclosed RICE platform may be implemented in different domains in a rapid way. It also has a potential of providing rich content to enterprise products such as Internet Protocol television (IPTV), service delivery platform (SDP), and Contact Center. The disclosed solutions may allow customers to acquire data from both internal and external data sources that include various numbers of domains/entities for creating an enriched and entity-centric knowledge base (KB), sometimes called RICE KB. RICE knowledge base may serve as a central knowledge base for enriching user experience in product lines as a value-added service.

The disclosed RICE for Big Data system may allow enterprises to quickly create their own knowledge bases with minimum effort. The disclosed data system may help data architects and engineers, developers, analysts, and managers to build custom solutions that fit their specific business needs, and further help organizations customize platforms to align to their existing processes. The disclosed data system may improve the processes and performance of knowledge generation by saving time, reducing operating costs, and freeing up resources to refocus on achieving a corporate mission. The disclosed data system may offer a powerful front-end for providing a centralized management interface with a consolidated repository of structured and unstructured data, in which the repository has been unified and enriched. Automated enrichment process may extract entities from each and every document, add value to the data, and allow insightful analysis. Such analysis may include predictive analytics, social media analysis, risk management, social monitoring, market research analysis, recommendation engines, and brand monitoring.

The disclosed data system may serve as an information integration platform that allows users to quickly and easily integrate data from a variety of data sources including databases, spreadsheets, delimited text files, Extensible Markup Language (XML), JavaScript Object Notation, and web APIs. The disclosed data system may also automate as much of the process as possible to allow end-users to map their data to a chosen ontology. Users may then adjust the automatically generated model using a graphical user interface. Thus, users may never need to see the complex mapping rules used in other systems and may need virtually no coding.

The disclosed data system may further integrate social data with customers, products, and web data to get a clearer picture of how social data is driving a business. Enterprises may benefit from the integration and analysis of local sources and web sources for business success. For instance, sales departments can leverage social data to research target companies and people; financial researchers can analyze company and industry trends to guide investment decisions; human resource (HR) managers and recruiters can find qualified candidates via social profiles and interests, and gain insight into prospective employees' work history; marketing departments can track campaign efficiency across target demographics gender and geography; product teams can track product launch success and compare results to previous launches; and customer service departments can turn detractors into advocates by responding quickly to customers inquiries and complaints.

RICE is a step toward a dream of connecting global knowledge by enabling distributed search. The disclosed embodiments may contribute to scientific and technical advancement on a global level, particularly in semantic web, semantic technology, and related areas. For instance, knowledge bases may be built by obeying semantic web design patterns and other semantic technologies.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. A method for building and managing a user-customizable knowledge base, the method comprising:
acquiring data related to a plurality of entities from a plurality of data sources based on a customized configuration, wherein the customized configuration specifies a distinct data wrapper for each of the data sources;
extracting entity-related information from the acquired data to form a plurality of graph structures; and
integrating the graph structures by mapping relationships between the entities to create an entity-centric knowledge base.

2. The method of claim 1, wherein the plurality of data sources comprise at least one internal data source with respect to an enterprise and one or more external data sources with respect to the enterprise, and wherein at least part of the relationships are mapped between entities of the internal data sources and entities of the external data sources.

3. The method of claim 1, wherein the customized configuration is defined by:
configuring a customizable data model for the entity-centric knowledge base;
configuring the data wrapper for each data source by defining rules for acquiring the data from the data sources and rules for extracting the entity-related information; and
configuring data integration and semantification rules.

4. The method of claim 1, further comprising:
collecting configuration information associated with each data source using a corresponding data wrapper prior to acquiring the data; and
constructing a metasearch engine by assembling the data sources as a group based on the collected configuration information.

5. The method of claim 4, wherein the metasearch engine implements a piped execution, and wherein acquiring the data based on the customized acquisition configuration comprises:
querying the data sources using the metasearch engine; and
forwarding the acquired data as search results to a unified metasearch engine result interface.

6. The method of claim 5, wherein each of the data sources is associated with a first form with first parameters, wherein the metasearch engine is associated with a second form with second parameters, and wherein searching the data sources using the metasearch engine comprises:
mapping the second parameters to corresponding first parameters;
converting a metasearch engine query to a search engine query based on the mapping of the parameters;
sending the search engine query to the data sources; and
mapping each field of a result record of each data source to a corresponding field of a result record of the metasearch engine.

7. The method of claim 6, wherein the customized acquisition configuration is configured via a Prompt Internet Information Integrator (PI3) platform, and wherein communications between the PI3 platform and the data sources are implemented as Representational State Transfer (REST) application programming interface (API) calls.

8. The method of claim 1, further comprising:
cleaning the acquired data to enhance data quality, wherein cleaning the data comprises:
normalizing the acquired data such that corresponding fields of the acquired data from the data sources have a common data format; and
filtering the acquired data to remove duplicative or incomplete entities; and
extracting metadata by annotating the acquired data with existing entities and entity relationships defined in the knowledge base.

9. The method of claim 1, wherein integrating the graph structures further comprises:
unifying formats of the graph structures according to one common data format before mapping the relationships; and
storing the entities and the mapped relationships in a Hadoop Distributed File System (HDFS).

10. The method of claim 1, further comprising:
executing user-defined enrichment rules for unifying data from heterogeneous internal and external sources with respect to an enterprise;
searching the entity-centric knowledge base for a specified entity; and
employing a custom data analysis tool to discover information associated with the entity using a custom data analysis tool.

11. A data system comprising one or more processors configured to:
acquire data related to a plurality of entities from a plurality of heterogeneous data sources based on a customized acquisition configuration;
extract entity-related information from the acquired data to form a plurality of graph databases; and
integrate the graph databases by mapping relationships between the entities to create an entity-centric knowledge base.

12. The data system of claim 11, wherein the customized acquisition configuration specifies a distinct data wrapper for each of the data sources, wherein the plurality of heterogeneous data sources comprise at least one internal data source with respect to an enterprise and one or more external data sources with respect to the enterprise, and wherein at least part of the relationships are mapped between entities of the internal data sources and entities of the external data sources.

13. The data system of claim 11, wherein the one or more processors are further configured to construct a metasearch engine by assembling the data sources as a group prior to acquiring the data, wherein acquiring the data based on the customized acquisition configuration comprises searching the data sources using the metasearch engine that is constructed by assembling the data sources as a group.

14. The data system of claim 13, further comprising at least one transceiver coupled to the one or more processors, wherein the customized acquisition configuration is configured via a Prompt Internet Information Integrator (PI3) platform, wherein each of the data sources is associated with a first form with first parameters, wherein the metasearch engine is associated with a second form with second parameters, and wherein searching the data sources using the metasearch engine comprises:
mapping the second parameters to corresponding first parameters;
converting a metasearch engine query to a search engine query based on the mapping of the parameters; and
instructing the at least one transceiver to send the search engine query to the data sources.

15. The data system of claim 11, wherein the one or more processors are further configured to clean the acquired data to enhance data quality, wherein cleaning the data comprises:
normalizing the acquired data such that corresponding fields of the acquired data from the data sources have a common data format; and
filtering the acquired data to remove duplicative or incomplete entities.

16. The data system of claim 11, wherein the relationships between the entities are discovered by analyzing acquired text data using a semantic analysis tool, and wherein integrating the graph databases further comprises:
unifying formats of the graph databases according to one common data format before mapping the relationships; and
storing the entities and the mapped relationships in a Hadoop Distributed File System (HDFS).

17. The data system of claim 11, wherein the one or more processors are configured to:
execute user-defined enrichment rules for unifying data from heterogeneous internal and external sources with respect to an enterprise; and
discover information associated with the entities using third party data analysis tools.

18. A computer program product comprising computer executable instructions stored on a non-transitory computer readable medium such that when executed by a processor cause a network system to:
acquire data related to a plurality of entities from a plurality of search engines based on a metasearch engine configuration;
generate an entity-centric knowledge base by establishing a mapping between the data related to the entities and an upper ontology that encompasses at least the search engines; and
analyze contents contained in the entity-centric knowledge base to discover information associated with each entity and relationships between the entities.

19. The computer program product of claim 18, wherein the metasearch engine configuration is configured using a Prompt Internet Information Integrator (PI3) platform, wherein each of the search engines is associate with first parameters, wherein the metasearch engine is associated with second parameters, and wherein acquiring the data comprises:
incorporating configuration information describing each search engine into a corresponding data wrapper;
mapping the second parameters to corresponding first parameters;
converting a metasearch engine query to a search engine query to be sent to the search engines based on the mapping of the parameters; and
mapping each field of a result record from each search engine to a corresponding field of a result record of the metasearch engine.

20. The computer program product of claim 18, wherein the mapping between the data and the upper ontology links a plurality of graph databases together as integral parts of the entity-centric knowledge base, and wherein generating the entity-centric knowledge base further comprises:
unifying data formats of the graph databases before establishing the mapping; and
storing the entities and the relationships in a Hadoop Distributed File System (HDFS).
